(19) United States
(12) Patent Application Publication
(10) Pub. No.: US 2025/0044116 A1
(43) Pub. Date: Feb. 6, 2025

(54) Method and computing device for generating a spatial and temporal map of estimated vessels traffic in an area

(71) Applicant: TotalEnergies OneTech, Courbevoie (FR)

(72) Inventor: Hélène BIDEAUD, Pau Cedex (FR)

(21) Appl. No.: 18/717,935

(22) PCT Filed: Dec. 9, 2021
(86) PCT No.: PCT/IB2021/000956

§ 371 Date: Jun. 7, 2024

(51) Int. Cl. G01C 21/00; G01C 21/20; G08G 3/00

(52) U.S. Cl. CPC G01C 21/3804; G01C 21/203; G08G 3/00

(57) ABSTRACT

The invention relates to a computing device or a method of generating a spatial and temporal map (50) of an estimated vessels traffic in an area (51), said method comprising the following steps: Acquisition (110) of a plurality of satellite radar images of the area (51), said plurality of satellite radar images having been generated over a period of at least twelve months at a median frequency lower than ten images per week; Analysis (120) of the plurality of satellite radar images to generate data on vessels forming an historical vessel traffic; Correction (130) of the generated data based on the plurality of satellite radar images frequency; and Generation (180), from the corrected data, of at least one spatial and temporal distribution map of vessels forming the estimated vessel traffic in the area, said spatial and temporal distribution map comprising vessel density values by time period.

### FIELD OF THE INVENTION

The present invention relates to the field of marine traffic. In particular, the invention relates to the field of vessels traffic analysis. This invention provides a method as well as a computing device for generating a spatial and temporal map of estimated vessels traffic in an area.

### DESCRIPTION OF RELATED ART

With increasing worldwide sea travel, fishing and transport of goods, ocean environment monitoring and monitoring human activities at sea are topics of increasing interest. This involves for example tracking and monitoring of illegal vessel activities, ship routing and monitoring of ship movements, oil spills, etc.

Monitoring vessel activities is of particular interest and many systems have been developed to reveal the presence and to individuate the activity of ships. An example is the automatic identification system (AIS), which exploits the identification data and information, that are transmitted by the ships equipped of such a system. In terrestrial AIS, the data are received by a ground station whereas in space-based AIS, the signals from ships are collected by satellites. MarineTraffic@ is a leading provider of ship tracking based on AIS. The ship tracking is in particular based on data gathered from a network of coastal AIS-receiving stations, supplemented by satellite receivers. Based on AIS technology, MarineTraffic@ receives, analyses and stores millions of vessels positions every day. However, the data generated lack information's on the vessels which are not equipped with AIS.

Space-based images have also been proposed for maritime surveillance. In particular, thanks to the capability for data acquisition under all weather and day-and-night conditions, satellite-based radar imagery, usually gathered by synthetic aperture radar (SAR), is becoming increasingly widespread for maritime surveillance. In SAR, an active microwave sensor can illuminate a target with a focused, directional beam of energy, producing unique scattering effect depending on the orientation of the sensed objects. The backscattering response of surface materials to illumination by microwave energy, also referred to a “backscattering signal”, is very different from spectral reflectance of the visible sunlight of the same material. Hence, SAR systems offer unique information regardless of weather or other conditions, with wide area coverage.

In the field of Earth observation, SAR became a useful tool for services related to security and the environment. For example, ship detection and identification based on SAR data is a key part of several services or system dealing in real time or quasi-real time with maritime traffic, illegal fisheries, or sea border activity, or with ocean and coastal management issues such as oil spill detection and monitoring.

One of the main challenges in ship detection is the presence of sea clutter inherent to coherent imagery. The ship detection algorithms such as constant false alarm rate (CFAR), alpha-stable algorithms, wavelet transforms have been implemented, but these algorithms are limited due to the presence of sea clutters and speckle noise in SAR images. Thus, it has recently been proposed the integration of synthetic aperture radar (SAR) images with data reported by the automatic identification system (AIS) for an effective monitoring of maritime activities. In particular, the false and missed alarm rates are estimated based on the number of ships detected by SAR which are confirmed by AIS which is used as a source of reference or ground truth data (Graziano et al. Integration of Automatic Identification System (AIS) Data and Single-Channel Synthetic Aperture Radar (SAR) Images by SAR-Based Ship Velocity Estimation for Maritime Situational Awareness. Remote Sens. 2019, 11(19), 2196). The proposed method limits the distance between the AIS report and the SAR-based detection to less than 150 m.

However, ship detection from AIS still has several problems to overcome since many ships with varying sizes and types do not have AIS or turn it off.

Moreover, such methods, if they seem to be adapted for real-time analysis or instant analysis of the vessel traffic, are not adapted for environmental and societal impact assessment studies. When planning an activity on a maritime area, and in particular on a coastal area, one wants to get a general information on the vessel traffic in order to plan at best its activity. Indeed, maritime traffic, including fisheries and tourism, have strong implications on offshore operations like seismic acquisition, drilling or installation of offshore infrastructure. Fishing boats can especially be problematic due to the lack of positioning information (absence of AIS), the variability of fishing areas during the year and their seasonality.

Hence, there is a need for solutions capable of generating a spatial and temporal map of estimated vessels traffic in an area in order to obtain a satisfactory situational understanding of vessels traffic over time in an area.

### SUMMARY OF THE INVENTION

The following sets forth a simplified summary of selected aspects, embodiments and examples of the present invention for the purpose of providing a basic understanding of the invention. However, the summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes a method of generating a spatial and temporal map of an estimated vessels traffic in an area, preferably in an offshore area, said method being implemented by one or more processors, said method comprising the following steps:
Acquisition of a plurality of satellite radar images of the area, said plurality of satellite radar images having been generated over a period of at least twelve months at a median frequency lower than ten images per week and said satellite radar images having a resolution from five to twenty meters;
Analysis of the plurality of satellite radar images to generate data on vessels forming an historical vessel traffic, including vessels not equipped with an automatic identification system;
Validation or correction of the generated data based on the plurality of satellite radar images frequency; and
Generation, from the validated or corrected data, of at least one spatial and temporal distribution map of vessels forming the estimated vessel traffic in the area, said spatial and temporal distribution map comprising vessel density values by time period.

The advantage of this methodology is that it gives a complete statistical picture of maritime traffic over time in a given area. All ships whose size is within the satellite's spatial resolution, even those without AIS, will be detected. Hence, a spatial and temporal map of an estimated vessels traffic in an area will be generated. Such map can be used to predict vessels traffic depending on the considered time period or other parameters. Such an estimation of the traffic allows to quickly identify differences in traffic within an area depending on various parameters such as the size of the boats and the time period.

According to other optional features of the method according to the invention, it can optionally include one or more of the following characteristics alone or in combination:
the generated data on vessels comprises position of the vessels, estimated length of the vessels and time information.
the generated data on vessels forming the vessels traffic includes vessels with a length of less than hundred meters, preferably less than fifty meters. Whereas AIS detection are limited to vessels having a turned on AIS and usually of a significant length, for example over 100 m, the present invention allows an estimation of traffic for small vessels, such as vessels of less than 100 meters.
further comprising a step of outlier′ detection, preferably the step of outlier′ detection comprising a comparison of a plurality of satellite radar images of a selected sub-area on several instants and an outlier detection when a vessel of the same length is detected at the same location on several instants.
at least one hundred satellite radar images are acquired for a same area at a frequency of at least two images per month, preferably at least five images per month.
further comprising a step of data improvement using data from the area selected from one or more of: automatic identification system data, night satellite images, and high-resolution satellite images.
further comprising a step of integrating data in a geographic information system pertaining to the area.
further comprising a step of defining a plurality of layers associated with one or more portions of the area, wherein the plurality of layers corresponds to a plurality of layer versions, and wherein each of the plurality of layer versions comprises data associated with different values of vessels length and/or time.
the plurality of layers comprises one or more attributes associated with types of information comprised in each of the plurality of layers, and optionally wherein the one or more attributes comprise a confidence attribute, value of the confidence attribute corresponding to a level of confidence in the accuracy of the data contained in the layer, and further optionally wherein the confidence attribute is based at least in part on a number of satellite radar images used to generate said layer of the plurality of layers, a source of the satellite radar images, or a method used to analyze the satellite radar images.
the plurality of layers comprises one or more of the following layers in a geographic information system project: results of automatic boat detection, an AIS layer, a night optical satellite image, high-resolution satellites image, offshore infrastructure, and other ancillary data depending on the geographical area.
the plurality of layers comprises a local coordinate system layer, the local coordinate system layer comprising information associated with a coordinate system used by the vessels to determine a local position of the vessels and transform the local position of the vessels to a distance between the vessels and a point of interest in the area.
the spatial and temporal distribution map comprises several layers, one layer being dedicated to the density of vessels over time.
further comprising a step of generating a score of sea traffic disturbance, said generation of the score of sea traffic disturbance comprising:
   determining, from Global Positioning Satellite information, a geographic portion of the studied area; and
   compute, for the geographic portion, a score of sea traffic disturbance based on vessels occurrence seasonality, and vessels length.

According to another aspect, the invention can also relate to a method of defining suitable shipping routes comprising a step of using a spatial and temporal map generated according to the invention.

The invention can also relate to a method of defining suitable maritime exploitation zone comprising a step of using a spatial and temporal map generated according to the invention.

Such a method of defining suitable maritime exploitation zones can comprise a step of defining a drilling zone.

According to another aspect, the present invention can also relate to one or more tangible non-transitory computer-readable media storing computer-readable instructions that when executed by one or more processors cause the one or more processors to perform a method according to the invention.

According to another aspect of the present invention, it is provided a computing system comprising: one or more processors; and one or more tangible non-transitory computer-readable media storing instructions that when executed by the one or more processors cause the one or more processors to perform operations comprising:
Acquisition of a plurality of satellite radar images of an area, said plurality of satellite radar images having been generated over a period of at least twelve months at a median frequency lower than ten images per week and said satellite radar images having a resolution from five to twenty meters;
Analysis of the plurality of satellite radar images to generate data on vessels forming an historical vessel traffic, including vessels not equipped with an automatic identification system;
Validation or correction of the generated data based on the plurality of satellite radar images frequency; and
Generation, from the validated or corrected data, of at least one spatial and temporal distribution map of vessels forming the estimated vessel traffic in the area, said spatial and temporal distribution map comprising vessel density values by time period.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view of a method of generating a spatial and temporal map of an estimated vessels traffic in an area according to the present invention.

FIG. 2 is an illustration of a spatial and temporal map of an area.

FIG. 3 is an illustration of satellite radar images. A. White spots correspond to boats that have a high backscattering response. B. Same image superimposed with the results of the automatic boat extraction on the radar image (black circles).

FIG. 4 is an illustration of a spatial and temporal map of an area with the position of the detected vessels based on satellite radar images.

FIG. 5 A, B, C, D are graphical illustrations of a density map for example using an output cell of 1000 m and a search radius of 25 km.

FIG. 6 is a graphical illustration of a computing device according to the invention.

FIG. 7 is a graphical illustration of a spatial distribution of detected vessels per month over 5 years Between April 2015 to April 2020.

Several aspects of the present invention are disclosed with reference to flow diagrams and/or block diagrams of methods, devices and computer program products according to embodiments of the invention.

On the figures, the flow diagrams and/or block diagrams show the architecture, the functionality and possible implementation of devices or systems or methods and computer program products, according to several embodiments of the invention.

For this purpose, each box in the flow diagrams or block diagrams may represent a system, a device, a module or code which comprises several executable instructions for implementing the specified logical function(s).

In some implementations, the functions associated with the box may appear in a different order than indicated in the drawings.

For example, two boxes successively shown, may be executed substantially simultaneously, or boxes may sometimes be executed in the reverse order, depending on the functionality involved.

Each box of flow diagrams or block diagrams and combinations of boxes in flow diagrams or block diagrams may be implemented by special systems that perform the specified functions or actions or perform combinations of special equipment and computer instructions.

### DETAILED DESCRIPTION

A description of example embodiments of the invention follows.

As used herein, the term “Vessels” can be considered as anything that can float and can be steered/moved. It can refer to ships, but also boats, floating platforms, barges.

By “process”, “compute”, “determine”, “display”, “extract”, “compare” or more broadly “executable operation” is meant, within the meaning of the invention, an action performed by a computing device or a processor unless the context indicates otherwise. In this regard, the operations relate to actions and/or processes of a data processing system, for example a computing system or an electronic computing device, which manipulates and transforms the data represented as physical (electronic) quantities in the memories of the computing system or other devices for storing, transmitting or displaying information. In particular, calculation operations are carried out by the processor of the device, the produced data are entered in a corresponding field in a data memory and this field or these fields can be returned to a user for example through a Human Machine Interface formatting such data. These operations may be based on applications or software.

The terms or expressions “application”, “software”, “program code”, and “executable code” mean any expression, code or notation, of a set of instructions intended to cause a data processing to perform a particular function directly or indirectly (for example after a conversion operation into another code). Exemplary program codes may include, but are not limited to, a subprogram, a function, an executable application, a source code, an object code, a library and/or any other sequence of instructions designed for being performed on a computing system.

By “processor” is meant, within the meaning of the invention, at least one hardware circuit configured to perform operations according to instructions contained in a code. The hardware circuit may be an integrated circuit. Examples of a processor include, but are not limited to, a central processing unit, a graphics processor, an application-specific integrated circuit (“ASIC” according to Anglo-Saxon terminology), and a programmable logic circuit. A single processor or several other units may be used to implement the invention.

By “coupled” is meant, within the meaning of the invention, connected, directly or indirectly, with one or more intermediate elements. Two elements may be coupled mechanically, electrically or linked by a communication channel.

The expression “human-machine interface”, within the meaning of the invention, corresponds to any element allowing a human being to communicate with a computer, in particular and without that list being exhaustive, a keyboard and means allowing in response to the commands entered on the keyboard to perform displays and optionally to select with the mouse or a touchpad item displayed on the screen. Another embodiment is a touch screen for selecting directly on the screen the elements touched by the finger or an object and optionally with the possibility of displaying a virtual keyboard.

By “computing device”, it should be understood any device comprising a processing unit or a processor, for example in the form of a microcontroller cooperating with a data memory, possibly a program memory, said memories possibly being dissociated. The processing unit cooperates with said memories by means of internal communication bus.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Within the meaning of the invention, the term “sub-area” refers to a predetermined part of an area. More particularly, an area may be subdivided in one or more sub-area.

The expression “route within the area” refers to a route from one point to another. The route may be defined by a line that goes through different points; each point may be characterized by geographic coordinates. Conversely,

The term “offshore area” corresponds to a maritime zone which does not include a coastal zone. Conversely, the term “coastal area” corresponds to a maritime zone which includes a coastal zone.

As mentioned, most of the developed methods related to marine traffic are specialized in real-time analysis or instant analysis of the vessel traffic. They are not adapted for environmental and societal impact assessment studies, or when we want to have a complete view on the maritime traffic, included vessels that do not have AIS. There is a need for a spatial and temporal map of an estimated vessels traffic in an area that can be used to predict vessels traffic depending on the considered time period or other parameters.

A method, based on satellite radar images has been developed. The analysis is carried out from satellite radar images taken at low frequency. This allows despite an analysis over a long period of time (i.e. over one year) to work on acceptable computing time. The solution of the invention allows performing quick studies with an estimation of the boats size which is a real asset for discriminating fishing boats from large tankers traffic.

The invention relates to the generation of an estimation of the traffic which can take the form of a map. Such an estimation of the traffic allows to quickly identify differences in traffic within an area depending on various parameters such as the size of the boats and the time period. The current methods do not allow a correct estimation of the traffic. Preferably, such a solution comprises generating boat density data by area and time period.

Hence, according to a first aspect, the invention relates to a method 100 of generating a spatial and temporal map 50 of an estimated vessels traffic. In particular, the map 50 of an estimated vessels traffic can be done for a particular area 51 of interest. As mentioned, coastal areas are challenging. The area 51 of interest is preferably an offshore area or a coastal area. It can comprise maritime areas 53 and terrestrial areas 54.

The method 100 is preferably implemented by one or more processors 10. The processor(s) 10 implementing the method according to the invention may be integrated into a computing device, such as a computer or a computer server, configured to receive a plurality of satellite radar images. A computing device 1 suitable for implementing the invention or configured to implement a method according to the invention will be further detailed in the remainder of this description.

A method according to the invention allows despite an analysis over a long period of time to work on acceptable computing time.

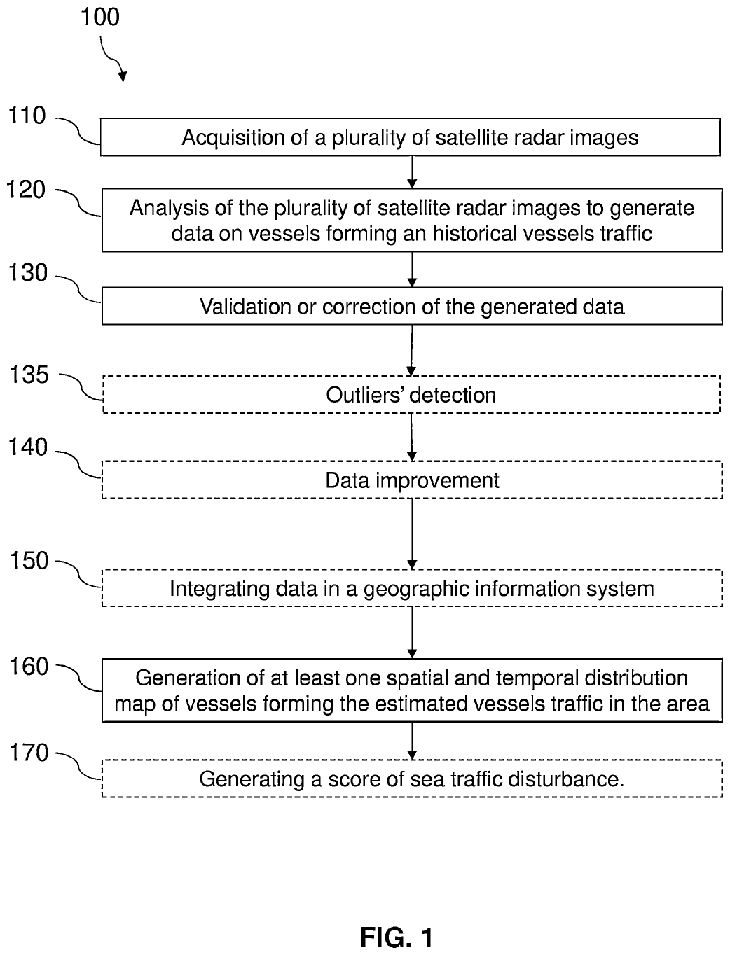

In particular, as illustrated in FIG. 1, a method 100 of generating a spatial and temporal map 50 of an estimated vessels traffic according to the invention will comprise the following steps: acquisition 110 of a plurality of satellite radar images of the area 51, analysis 120 of the plurality of satellite radar images to generate data on vessels forming historical vessel traffics, validation or correction 130 of the generated data and generation 160 of at least one spatial and temporal distribution map of vessels forming the estimated vessel traffics in the area.

A method according to the invention can also comprise the following steps: a step of outliers' detection 135, a step of data improvement 140, a step of generating 170 a score of sea traffic disturbance and/or a step of integrating 150 the data in a geographic information system.

As shown in FIG. 1, a generating method 100 according to the invention comprises a step of acquiring 110 a plurality of satellite radar images, in particular satellite radar images of the area 51.

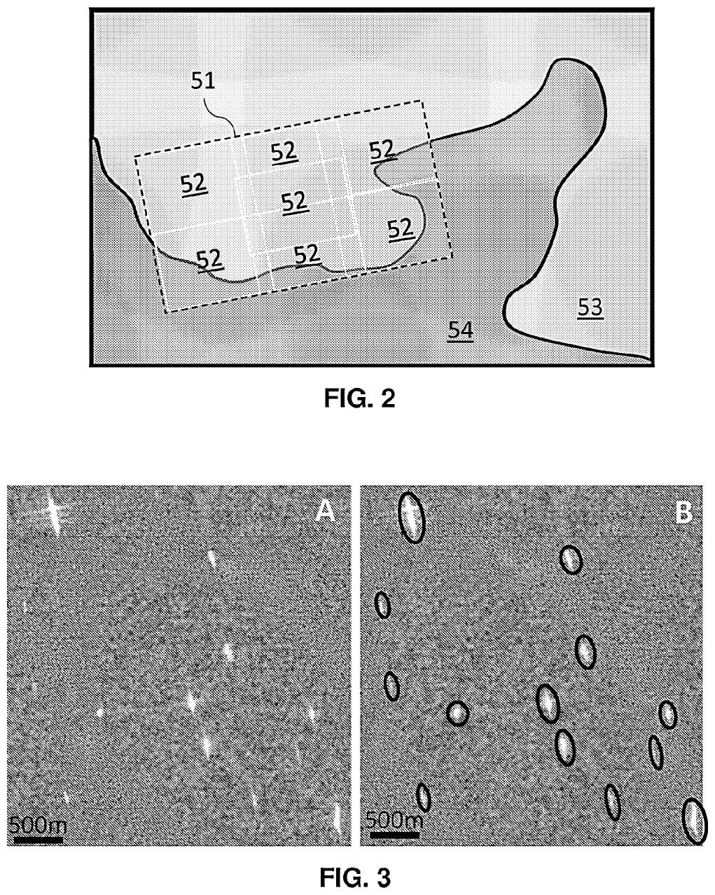

As illustrated in FIG. 2, an area 51 can correspond to several satellite radar images 52. Such a tiling of the images allows an analysis of a large area that could not be covered by a single satellite radar image.

A method according to the invention can comprise the use of several satellite radar images covering different parts of the area but will comprise the use of several satellite radar images covering different moments in the time period considered. Preferably, at least one hundred satellite radar images are acquired at different times in a same area 51. More preferably, at least two hundred satellite radar images 52 are acquired at different times for a same area 51 and even more preferably at least four hundred satellite radar images 52 are acquired at different times for a same area 51. Preferably, the satellite radar images are historical data pertaining to the area 51 of interest. For example, the plurality of satellite radar images has been generated over a period of at least twelve months, preferably over a period of at least twenty-four months, more preferably over a period of at least thirty-six months and even more preferably over a period of at least forty-eight months. With historical data of such an extent, the invention allows a seasonal analysis of the vessels traffic and also a tendency evaluation of the vessels traffic in the area 51.

This step can be in particular designed to load into memory all the images needed to perform the invention.

State-of-the-art methods have been designed to maximize the accuracy of the vessels traffic analysis at the expense of speed and costs. Hence, preferably, the plurality of satellite radar images acquired and used in the present invention has a median frequency lower than ten images per week. More preferably, the plurality of satellite radar images acquired and used in the present invention has a median frequency lower than eight images per week, even more preferably lower than six images per week.

However, to get an accurate estimate of the vessels traffic in an area, the median frequency of the plurality of satellite radar images should be of at least two images per month, preferably at least four images per month, more preferably at least six images per month.

Preferably, the satellite radar images used in the present invention have a resolution of 20 meters or less. More preferably, the satellite radar images used in the present invention have a resolution ranging from 5 to 20 meters.

Where state-of-the-art methods have been developed to analyze with a high precision and in real time high resolution satellite radar images, an advantage of the present invention is to be able to compute a high number of satellite radar images to produce a robust estimation of the vessels in an area 51 over time.

Hence preferably, at least one hundred satellite radar images are acquired for a same area 51. More preferably, at least two hundred satellite radar images 52 are acquired for a same area 51 and even more preferably at least four hundred satellite radar images 52 are acquired for a same area 51.

As shown in FIG. 1, a generating method 100 according to the invention comprises a step of analyzing 120 the plurality of satellite radar images. This step is in particular designed to generate data on vessels. An advantage of the present invention is that the proposed solution can include an analysis of the vessels not equipped with an automatic identification system.

This generated data on vessels can be considered as forming an historical vessel traffic. However, this generated data corresponds to only a part of the historical vessels traffic as the frequency of the acquired satellite radar images is not continuous. Indeed, a lot of information of the real vessel traffic is not captured by the analysis based on the scarcity of the raw data used.

The generated data on vessels can comprise data on a position of the vessels and/or data on an estimated length of the vessels. These data are associated with time information. The time information can be in particular the time at which the satellite image was taken.

Preferably, the generated data on vessels comprises a position of the vessels. The position of the vessels will be reported according to a global navigation satellite system such as the Global Positioning System (GPS), the Global Navigation Satellite System (GLONASS), the BeiDou Navigation Satellite System (BDS) and the Galileo system.

Preferably, the generated data on vessels comprises an estimated length of the vessels. The estimated length of the vessels can be calculated through an image processing.

As illustrated in the FIGS. 3A and 3B, vessels are associated, in satellite radar images, with luminous and diffracting points.

Several methods can be used to generate data on vessels from the satellite radar images. Such methods are preferably configured to identify the vessels and generate an estimated value of their length. For example, as illustrated in FIG. 3B, a computer vision algorithm can be configured to detect vessels and calculate an estimated value of their length through via the use of a box surrounding a bright point assigned to a vessel.

Moreover, the generated data on vessels forming the vessel traffic includes vessels with a length of less than 100 meters, preferably less than 50 meters, more preferably less than 30 meters. In particular, the generated data on vessels forming the vessel traffic includes all the vessels with a length of 20 meters or more.

In an embodiment, the computer vision algorithm has been previously trained or configured.

Machine learning is now widely adopted in computer vision fields. Trained models can be divided into models generated through unsupervised learning methods and models generated through supervised learning methods. The unsupervised learning methods make it possible to determine groups of observations without an a priori. Hence, those groups will be formed without a need for a label value on input data. On the contrary, the supervised learning methods link an input to an output based on example input-output pairs.

In the present invention, a machine learning technique can be used to build a supervised prediction model configured to calculate vessels position and/or calculate an estimated value of their length. Among supervised learning methods, neural networks, classification or regression trees, nearest neighbour search, and random forest are some of the most robust and efficient machine learning techniques according to the invention.

Regarding the detection of vessels from a satellite radar images, several methods are available. Methods of ship detection using SAR data are usually based either on CFAR detectors or on image transformation and, typically, the wavelet transform. Benchmarking for operational detection systems was carried out in the Detection and Classification of Maritime Traffic from Space project (Harm Greidanus, Benchmarking operational SAR ship detection, IEEE Int'l. Geosci. Remote Sens. Symp. 2004 6, pp. 4215-4218, 2004).

CFAR algorithm is widely used for computing an adaptive threshold. The use of a CFAR algorithm generally comprises a determination of a Probability Density Function (PDF) that can adequately describe the statistical characteristics of background.

Multilook SAR images can be used in a method according to the invention. For multilook SAR images, a commonly used PDF is the Gaussian distribution.

Also, a model for ship detection has been developed using the various beam modes for C-band SAR (Touzi et al. Optimization of the Degree of Polarization for Enhanced Ship Detection Using Polarimetric RADARSAT-2. in IEEE Transactions on Geoscience and Remote Sensing, vol. 53, no. 10, pp. 5403-5424, October 2015). This model was used to estimate the minimum ship's length based on the comparison of radar cross-section (RCS) of ships as well as the ocean. Successful SAR detection of ships depends, nevertheless, on the size and type of vessel, prevailing wind speed conditions, SAR resolution used and viewing angles. Lin and Khoo presented a general concept for the ship speed estimation using an azimuth shift concept with known course from the range direction. The distributions such as Gamma or K- distribution have also been suggested by Jiang et al. but they carry the same limitations as the Gaussian distribution. In general, as sea clutter in SAR images always shows spiky or heavy-tailed characteristics, these distributions often fail to describe heavy-tailed sea clutter in many actual applications.

Another method relies on a modification of the Search for Unidentified Maritime Objects (SUMO) detector introduced by the Joint Research Center of the European Community. In this approach, the detection process is applied to small parts (1500*400 pixels) of a SAR image. The mean brightness and standard deviation are calculated for each tile, and its value is compared with three different thresholds to determine whether it can be characterized as a target.

As shown in FIG. 1, a generating method 100 according to the invention comprises a step of validating or correcting 130 the generated data.

As the frequency of the satellite radar images can vary in time and in space, the applicant has established that the generated data from satellite image analysis over a period of 12 months or more should be corrected.

Hence, the step of validating or correcting 130 the generated data can comprise a first sub step of identifying a variation in frequency of the satellite radar images. When there is no variation, the generated data can be validated. When a variation of frequency is identified, the generated data can be corrected.

This step can in particular comprise a normalization of the generated data according to the satellite images frequencies. For example, the satellite radar images sampling rate over time can be used to correct the estimated number of vessels in an area over time.

As shown in FIG. 1, a generating method 100 according to the invention can further comprise a step of detecting outlier 135.

Whereas the step of analysis can implement optimized methods, it can still remain a need for an outliers' detection and an outliers' suppression.

Preferably, the step of outliers' detection 135 comprises a comparison of a plurality of satellite radar images of a selected sub-area of several instants.

There is for example an outliers' detection when a vessel of the same length is detected at the same location on several instants.

As shown in FIG. 1, a generating method 100 according to the invention can further comprise a step of improvement of the data 140, either the improvement being done on the generated data, the validated data or the corrected data.

The present invention is mainly based on satellite radar images. However, the solution can benefit from other data such as automatic identification system data, satellite infrared night images and/or satellite high-resolution images.

The automatic identification system data can for example be used to complete or to normalize the generated data.

The satellite infrared night images can be used to capture lowlight emission sources from both natural and anthropogenic sources and hence detect maritime night activities.

The high-resolution satellite images can be used to capture small boats (8-15 meters) and hence detect maritime night activities.

As shown in FIG. 1, a generating method 100 according to the invention can comprise a step of integrating 150 the data in a geographic information system.

An advantage of the present invention is that it can be used to give an information on the estimated vessels traffic over an area, depending on a temporal period and a position (e.g. sub-area).

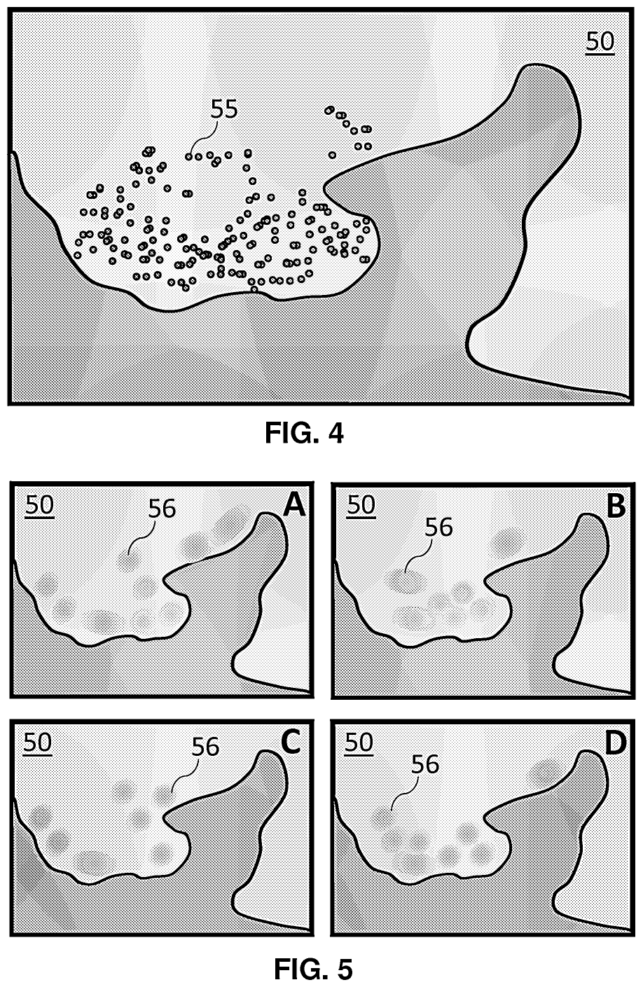

As illustrated in FIG. 4, each time a vessel is spotted during the analysis 120 of the plurality of satellite radar images, it can generate a data comprising a position of the vessel, a time and an estimated length. An intensive and impressive boat traffic is located all along the coast and on the shelf, whatever the year. More offshore, the maritime traffic appears more moderate. Such information can be included in a geographic information system in connection with a map.

Moreover, the geographic information system data can include static feature values associated with vessels in the area, the static features comprising for example the width of the vessels.

A method according to the invention can also comprise a step of defining a plurality of layers associated with one or more portions of the area, wherein the plurality of layers corresponds to a plurality of layer versions. For example, the plurality of layer versions can comprise data associated with different values of vessels length and/or time.

In FIG. 5A, 5B, 5C, 5D, has been illustrated a layer based on the density of vessels 56 in function of a time period (e.g. 5A: Summer; 5B: Autumn, 5C: Winter; 5D: Spring). Each of these illustrations can relates to a particular layer dedicated to a particular season.

The plurality of layers can relate to one or more of the following layers, preferably in a geographic information system: results of automatic boat detection, an AIS layer, a night optical satellite images, a high-resolution satellite images, offshore infrastructures and other ancillary data depending on the geographical area.

The results of automatic boat detection can correspond to the generated data on vessels forming the historical vessel traffic.

Advantageously, the plurality of layers comprises a local coordinate system layer, the local coordinate system layer comprising information associated with a coordinate system used by the vessels to determine a local position of the vessels and transform the local position of the vessels to a distance between the vessels and a point of interest in the area.

More preferably, the spatial and temporal distribution map comprises several layers, one layer being dedicated to the density of vessels 56 over time.

According to the invention, the plurality of layers can comprise one or more attributes associated with types of information comprised in each of the plurality of layers.

For example, the one or more attributes can comprise a confidence attribute, the value of the confidence attribute corresponding to a level of confidence in the accuracy of the data contained in the layer. Also, the confidence attribute can be calculated based at least in part on a number of satellite radar images used to generate said layer of the plurality of layers, a source of the satellite's radar images, or a method used to analyze the satellites radar images.

As shown in FIG. 1, a generating method 100 according to the invention comprises a step of generating 160 of at least one spatial and temporal distribution map of vessels 55 forming the estimated vessels traffic in the area.

This step can be in particular designed to aggregate the information generated over a long period of time in a comprehensible manner.

As illustrated in FIG. 5A, 5B, 5C, 5D, the generated spatial and temporal distribution map comprise vessel density values by time period generation 160.

Preferably, the spatial and temporal distribution map may comprise information on the length of the vessels, per period and/or per area. Also, the spatial and temporal distribution map can be configured such as vessel data can be exported according to a selected period or a selected area.

As shown in FIG. 1, a generating method 100 according to the invention comprises a step of generating 170 a score of sea traffic disturbance.

An advantage of the present invention is to analyze the historical data on vessel traffic in order to produce treated data useful in a context of marine projects having a lesser impact on environmental and human activity on the sea.

In particular, the invention can comprise a step of generating a score of sea traffic disturbance which will reflect a predicted level of marine activity function of the time. A score of sea traffic disturbance can be calculated for an area but will be preferably calculated for a sub-area or for a route within the area.

In particular, a method according to the invention can comprise computing, for a geographic portion or a sub-area, a score of sea traffic disturbance based on vessels occurrence seasonality, and vessels length. The vessels occurrence seasonality can relate to an estimated number of vessels over several periods of time.

Preferably, a method according to the invention will comprise computing a spatial distribution of vessels per month. As already stated, the number of vessels is preferably normalized with the image frequency during the period of observation.

Preferably, a method according to the invention can comprise computing an inter year variability. More preferably, a method according to the invention can comprise computing a trend on the evolution of traffic vessels over a period of time.

A solution according to the present invention will be of use in a number of costal or offshore development. In particular such solution can be of use in the context of environmental and societal impact assessment studies, or any offshore operations. Indeed, the generated spatial and temporal distribution map is an estimation of the vessels traffic much more precise than the ones that can be obtained through AIS.

Application of such solution can be for defining suitable shipping routes, defining suitable maritime exploitation zone

Hence, in another aspect, the invention relates to a method of defining suitable shipping routes comprising the use of a spatial and temporal map generated according to the invention.

This method can comprise a step of integrating in the spatial and temporal map a definition of upstream criteria such as a period during which the road is to be generated, or a duration of “road tranquillity”.

In another aspect, the invention relates to a method of defining suitable maritime exploitation zone comprising the use of a spatial and temporal map generated according to the invention. Such a method can be used before defining offshore wind fields, liquefied gas exploitation plants or offshore platforms positioning.

Hence, the invention can relate to a method of defining suitable maritime exploitation zone 300 comprising a step of defining a drilling zone.

As it will be appreciated by the one skilled in the art, aspects of the present invention may be embodied as a device, system, method or computer program product. Accordingly, aspects of the present invention may take the form of a fully hardware embodiment, a fully software embodiment (including firmware, resident software, microcode, etc.) or a mode of operation. In addition, aspects of the present invention may take the form of a computer program product incorporated into one or more computer-readable media having a computer readable program code embedded therein.

Thus, in another aspect, the invention relates to one or more computer-readable media storing computer-readable instructions that when executed by one or more processors 10 cause the one or more processors to perform a method according to the invention. Preferably, the computer-readable media is a tangible non-transitory computer-readable media.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g. a hard disk drive or floppy disk drive), a sequential access storage device (e.g. a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

In particular, any combination of one or more computer-readable media may be used. In the context of this document, a computer-readable medium may be any tangible medium that may contain, or store, a program for use by or in connection with an instruction execution system, apparatus, or device. A computer-readable medium may be, for example, but not limited to, an electronic, magnetic, optical, electromagnetic, infrared or semiconductor system, apparatus or device, or any suitable combination of the foregoing. More specific examples (a non-exhaustive list) of the computer-readable storage medium would include: a hard disk, a random-access memory (RAM).

Computer program code for performing operations for aspects of the present invention may be written in any combination of one or more programming languages, including an object-oriented programming language such as Java, C++, or similar, the programming language “C” or similar programming languages, a scripting language such as Perl, or similar languages, and/or functional languages such as Meta Language. Program code can run entirely on a user's computer, partly on a user's computer, and partly on a remote computer or entirely on the computer or remote server. In the latter scenario, the remote computer can be connected to a user's computer by any type of network, including a local area network (LAN) or a wide area network (WAN).

These computer program instructions may be stored on a computer readable medium that can direct a computing device (i.e. computer, server . . . ), so that the instructions stored in the computer-readable medium produce a computing device configured to implement the invention.

Hence, in another aspect, the invention relates a computing device 1 configured to generate a spatial and temporal map 50 of estimated vessels traffic in an area 51, preferably in an offshore area.

In particular, the computing device 1 is configured to implement a method according to the invention.

For purposes of this disclosure, a computing device 1 according to the invention may include any instrumentality or aggregate of instrumentalities operable to compute, classify, process, transmit, receive, retrieve, originate, switch, store, display, manifest, detect, record, reproduce, handle, or utilize any form of information, intelligence, or data.

For example, a computing device may be a personal computer, a network storage device, or any other suitable device and may vary in size, shape, performance, functionality, and price. The computing device may include random access memory (RAM), one or more processing resources such as a central processing unit (CPU) or hardware or software control logic, ROM, and/or other types of nonvolatile memory. Additional components of the computing device may include one or more disk drives, one or more network ports for communication with external devices as well as various input and output (I/O) devices, such as a keyboard, a mouse, and a video display. The computing device may also include one or more buses operable to transmit communications between the various hardware components.

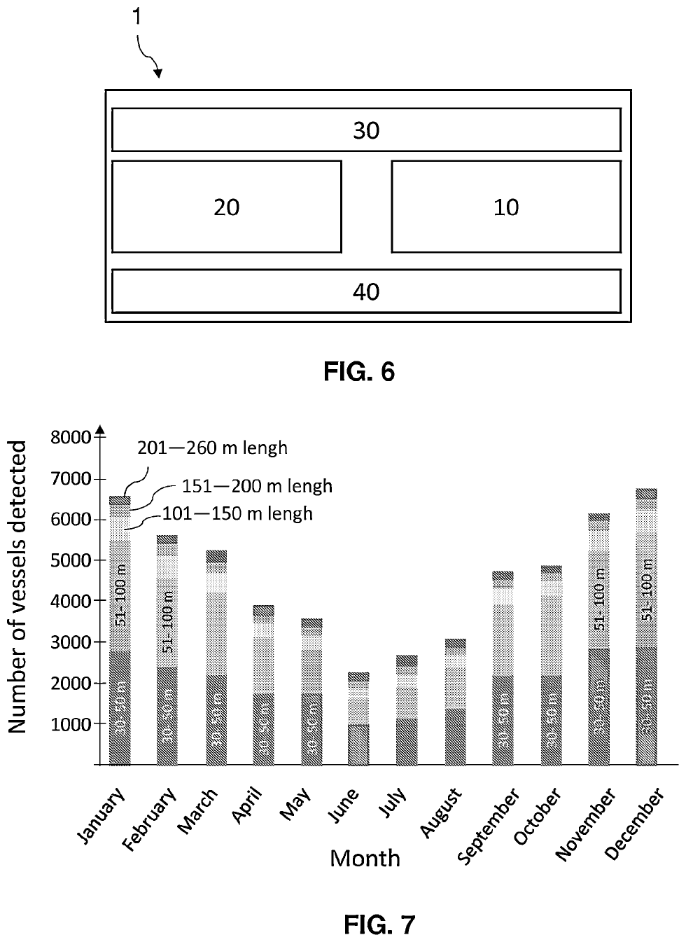

FIG. 6 is a schematic block diagram illustrating various hardware components that may be utilized in the computing device 1 according to the invention.

In particular, as illustrated in FIG. 6, the computing device 1 comprises: one or more memory components 20 configured to store a plurality of satellite radar images of the area 51 and instructions for the processor(s), one or more communication interfaces 30 configured to acquire a plurality of satellite radar images of the area 51; and one or more processors 10 configured to process the plurality of satellite radar images to generate at least one spatial and temporal distribution map. It can also comprise one or more user interfaces 40.

A computing device 1 for generating a spatial and temporal map 50 of an estimated vessels traffic in an area 51 may comprise a memory component 10.

The memory component 20 may comprise any computer readable medium known in the art including, for example, a volatile memory, such as a static random access memory (SRAM) and a dynamic random-access memory (DRAM), and/or a non-volatile memory, such as read-only memory, flash memories, hard disks, optical disks and magnetic tapes. The memory component 20 may include a plurality of instructions or modules or applications for performing various functions. Thus, the memory component 10 can implement routines, programs, or matrix-type data structures. Preferably, the memory component 20 may comprise a medium readable by a computing system in the form of a volatile memory, such as a random-access memory (RAM) and/or a cache memory. The memory component 20, like the other modules, can for example be connected with the other components of the computing device 1 via a communication bus and one or more data carrier interfaces.

The memory component 20 is preferably configured to store a plurality of satellite radar images. The memory component 20 can be configured to store models used and/or generated data.

Moreover, the memory component 20 is preferably configured to store instructions capable of implementing the method according to the invention.

Furthermore, the computing device 1 can also comprise a communication interface 30. The communication interface 30 is preferably configured to transmit data on at least one communication network and may implement a wired or wireless communication. The computing device 1 can communicate with other devices or computing systems and in particular with clients thanks to the communication interface 30. For example, communication interfaces 30 enable the computing device 1 to receive satellite radar images from another computer. Preferably, the communication is operated via a wireless protocol such as Wi-Fi, 3G, 4G, 5G and/or Bluetooth. These data exchanges may take the form of sending and receiving files. For example, the communication interface 30 may be configured to transmit a printable file. The communication interface may in particular be configured to allow the communication with a remote terminal, including a client. The client is generally any hardware and/or software capable of communication with the computing device 1.

A communication interface 30 according to the invention is, in particular, configured to exchange data with third-party devices or systems.

A communication interface 30 configured to acquire a plurality of satellite radar images.

A computing device 1 for generating a spatial and temporal map 50 of an estimated vessels traffic may comprise one or more processors 10. A processor 10 may be operably coupled to the memory component 10 to execute instructions, encoded in programs, for carrying out the presently disclosed techniques, more particularly to perform the method according to the invention.

The encoded instructions may be stored in any suitable article of manufacture (such as the memory component 20) that includes at least one tangible non-transitory, computer-readable medium that at least collectively stores these instructions or routines. In this manner, the memory component 20 may contain a set of instructions that, when executed by the processor 10, performs the method of the invention.

The memory component 20 may include any number of databases or similar storage media that can be queried from the processor 10 as needed to perform the method of the invention. In particular, the processor 10 is configured to analysis the plurality of satellite radar images to generate data on vessels forming an historical vessel traffic, including vessels not equipped with an automatic identification system.

The processor 10 can also be configured to apply a correction to the generated data based on the plurality of satellite radar images frequency.

The processor 10 can also be configured to generate, from the corrected data, of at least one spatial and temporal distribution map of vessels forming the estimated vessel traffic in the area, said spatial and temporal distribution map comprising vessel density values by time period.

These different modules or components are separated in FIG. 6, but the invention may provide various types of arrangement, for example a single module cumulating all the functions described here. Similarly, these modules or components may be divided into several electronic boards or gathered on a single electronic board.

A computing device 1 according to the invention can be incorporated into a computing system and able to communicate with one or several external devices such as a keyboard, a pointer device, a display, or any device allowing a user to interact with the device 1.

The computing device 1 may also be configured to communicate with or via a human-machine-interface. Thus, in one embodiment of the present invention, the computing device 1 can be coupled to a human interface machine (HMI). The HMI may be used to allow the transmission of parameters to the devices or conversely make available to the user the values of the data measured or calculated by the device.

In general, the HMI is communicatively coupled to a processor and includes a user output interface and a user input interface. The user output interface may include an audio and display output interface and various indicators such as visual indicators, audible indicators and haptic indicators.

The user input interface may include a keyboard, a mouse, or another navigation module such as a touch screen, a touchpad, a stylus input interface, and a microphone for inputting audible signals such as a user speech, data and commands that can be recognized by the processor.

### Example

### Acquisition

In an exemplified embodiment of the invention, over 900 Sentinel-1 radar images were used on a forty-eight-month period and covered very large surfaces (170×250 km).

The image coverage is good with between 50 and 400 images per point (mean of 228).

The spatial coverage is quite heterogeneous, the coastal and northern part of the displaying a higher coverage of radar data.

The method according to the invention allows the detection of over 50,000 boats in an area of about 35,000 km2.

After the image is registered, the land can be masked. In some cases, a preprocessing step is necessary to provide more accurately calibrated SAR data. The following step is the detection process which uses constant false alarm rate (CFAR). Then a discrimination step is used to reject false alarms where target measurements or characterization of oceanographic or meteorological phenomena are available.

All boats with a size >20 m are detected and an estimate of the vessel's length is generated.

### Obtained Data

The table 1 hereafter comprises the number of analyzed images per year.

TABLE 1

| | Number of images | Number of vessels |
|---|---|---|
| 2015 (from April) | 54 | 4870 |
| 2016 | 85 | 4456 |
| 2017 | 134 | 8684 |
| 2018 | 246 | 13244 |
| 2019 | 349 | 18688 |
| 2020 (until March) | 83 | 5443 |
| Total | 951 | 55 385 vessels |

The table 1 shows that the distribution of images per month increases during the study period: ˜7 images per month early 2015, then ˜12 images per month from March 2017 until June 2018, and finally ˜27 images per month since June 2018 Table 1.

According to the invention, the monthly distribution of boats detected has been normalized by the number of images. It shows that the maritime traffic is seasonal, with a decrease in boats traffic during summer periods (FIG. 7).

The size of detected boats ranges between 30 m to 260 m in estimated length. FIG. 7 shows that the boat traffic is dominated by “small” boats ranging from 30 m to 50 m long and “median” boats ranging from 50 m to 100 m long. The tankers (e.g. 200 m long), equipped with AIS, only represent a restricted portion of the maritime traffic in this area. Boats with size ranging from 100 m to 150 m are also located along the coast and over the continental shelf.

A very high density of boats is detected from November to March, mainly along the West Coast but also in the south. The period from May to August is the quietest regarding boat traffic.

An in-depth analysis of these maps can be done with layers each related to one size of vessels. For example, density map can be calculated using Kernel density toolbox in ArcMap, using an output cell of 1000 m and a search radius of 25 km.

Such data generated thanks to the present invention car be used to detect massive boats traffic along the coast and on the shelf. Advantageously, generated data is consolidated by means of several months or years of data aggregation.

It allows to differentiate the maritime traffic according to the period of time considered and thus to anticipate the traffic to come. Whereas actual methods are aiming to generate highly precise real time data

vessels traffic assessment, using satellite radar images provides additional information compared to AIS data (Automatic Identification System) used by many maritime traffic providers such as MarineTraffic. The temporal and spatial distribution of vessels allows optimizing operations and reduce HSE risks. Moreover, the low frequency of the image used allows performing quick studies for predicting vessel density according to the estimated length and the time period considered.

1. Method of generating a spatial and temporal map of an estimated vessels traffic in an area said method being implemented by one or more processors, said method comprising the following steps:
Acquisition of a plurality of satellite radar images of the area, said plurality of satellite radar images having been generated over a period of at least twelve months at a median frequency lower than ten images per week and said satellite radar images having a resolution from five to twenty meters;
Analysis of the plurality of satellite radar images to generate data on vessels forming an historical vessel traffic, including vessels not equipped with an automatic identification system;
Validation or correction of the generated data based on the plurality of satellite radar images frequency; and
Generation, from the validated or corrected data, of at least one spatial and temporal distribution map of vessels forming the estimated vessel traffic in the area, said spatial and temporal distribution map comprising vessel density values by time period.

2. Method of generating a spatial and temporal map according to claim 1, wherein the generated data on vessels comprises positions of the vessels, estimated lengths of the vessels and time information.

3. Method of generating a spatial and temporal map according to claim 1, wherein the generated data on vessels forming the vessels traffic includes vessels with a length of less than hundred meters.

4. Method of generating a spatial and temporal map according to claim 1, further comprising a step of outlier detection, the step of outlier detection comprising a comparison of a plurality of satellite radar images of a selected sub-area on several instants and an outlier detection when a vessel of the same length is detected at the same location on several instants.

5. Method of generating a spatial and temporal map according to claim 1, wherein at least one hundred of said satellite radar images are acquired for a same area at a frequency of at least two images per month.

6. Method of generating a spatial and temporal map according to claim 1, further comprising a step of data improvement using data from the area selected from one or more of: automatic identification system data, night satellite images, and high-resolution satellite images.

7. Method of generating a spatial and temporal map according to claim 1, further comprising a step of integrating data in a geographic information system pertaining to the area.

8. Method of generating a spatial and temporal map according to claim 1, further comprising a step of defining a plurality of layers associated with one or more portions of the area, wherein the plurality of layers corresponds to a plurality of layer versions, and wherein each of the plurality of layer versions comprises data associated with different values of vessels length and/or time.

9. Method of generating a spatial and temporal map according to claim 8, wherein the plurality of layers comprises one or more attributes associated with types of information comprised in each of the plurality of layers, and optionally wherein the one or more attributes comprise a confidence attribute, value of the confidence attribute corresponding to a level of confidence in the accuracy of the data contained in the layer, and further optionally wherein the confidence attribute is based at least in part on a number of satellite radar images used to generate said layer of the plurality of layers, a source of the satellite radar images, or a method used to analyze the satellite radar images.

10. Method of generating a spatial and temporal map according to claim 8, wherein the plurality of layers comprises one or more of the following layers in a geographic information system project: results of automatic boat detection, an AIS layer, a night optical satellite image, high-resolution satellites image, offshore infrastructure, and other ancillary data depending on the geographical area.

11. Method of generating a spatial and temporal map according to claim 8, wherein the plurality of layers comprises a local coordinate system layer, the local coordinate system layer comprising information associated with a coordinate system used by the vessels to determine a local position of the vessels and transform the local position of the vessels to a distance between the vessels and a point of interest in the area.

12. Method of generating a spatial and temporal map according to claim 1, wherein the spatial and temporal distribution map comprises several layers, one layer being dedicated to the density of vessels over time.

13. Method of generating a spatial and temporal map according to claim 1, further comprising a step of generating a score of sea traffic disturbance, said generation of the score of sea traffic disturbance comprising:
determining, from Global Positioning Satellite information, a geographic portion of a studied area; and
computing for the geographic portion, a score of sea traffic disturbance based on vessels occurrence seasonality, and vessels length.

14. Method of defining suitable shipping routes comprising a step of generating a spatial and temporal map according to the method of claim 1.

15. Method of defining suitable maritime exploitation zone comprising a step of generating the spatial and temporal map generated according to the method of claim 1.

16. Method of defining suitable maritime exploitation zones according to the claim 15 comprising a step of defining a drilling zone.

17. One or more tangible non-transitory computer-readable media storing computer-readable instructions that when executed by one or more processors cause(s) the one or more processors to perform the method of claim 1.

18. A computing device comprising: one or more processors; and one or more tangible non-transitory computer-readable media storing instructions that when executed by the one or more processors cause(s) the one or more processors to perform operations comprising:
Acquisition of a plurality of satellite radar images of an area, said plurality of satellite radar images having been generated over a period of at least twelve months at a median frequency lower than ten images per week and said satellite radar images having a resolution comprised between 5 and 20 meters;
Analysis of the plurality of satellite radar images to generate data on vessels forming an historical vessel traffic, including vessels not equipped with an automatic identification system;
Validation or correction of the generated data based on the plurality of satellite radar images frequency; and
Generation, from the validated or corrected data, of at least one spatial and temporal distribution map of vessels forming the estimated vessel traffic in the area, said spatial and temporal distribution map comprising vessel density values by time period.
